(19) United States
(12) Patent Application Publication
(10) Pub. No.: US 2012/0008097 A1
(43) Pub. Date: Jan. 12, 2012

(54) MANUFACTURING METHOD OF PROJECTION APPARATUS, MANUFACTURING EQUIPMENT OF PROJECTION APPARATUS, AND PROJECTION APPARATUS

(75) Inventors: Takuma OKAMURO, Suwa (JP); Osamu ISHIBASHI, Matsumoto (JP)

(73) Assignee: SEIKO EPSON CORPORATION, Tokyo (JP)

(21) Appl. No.: 13/112,229

(22) Filed: May 20, 2011

(30) Foreign Application Priority Data
Jul. 8, 2010 (JP) 2010-155491

(51) Int. Cl. G03B 21/14

(52) U.S. Cl. 353/20; 353/121

(57) ABSTRACT

A manufacturing method of a projection apparatus includes forming a modulation device unit in which a reflective light modulation device and a reflective polarizer are fixed to predetermined relative positions, and adjusting a position of the reflective light modulation device relative to a projection optical device by shifting a position of the modulation device unit with respect to the projection optical device.

### BACKGROUND

1. Technical Field

The present invention relates to a manufacturing method of a projection apparatus including a light modulation device and a projection optical device that projects light modulated by the light modulation device, manufacturing equipment of the projection apparatus, and a projection apparatus.

2. Related Art

A projector including a light modulation device that modulates luminous flux output from a light source and a projection optical device that enlarges and projects the luminous flux modulated by the light modulation device is known. As the light modulation device, a transmissive or reflective light modulation device is known. In the projector, it is necessary to appropriately adjust the positional relationship between the projection optical device and the light modulation device for formation of a preferable projection image. For example, in a projector that projects a color image using light sources of three colors, it is necessary to appropriately adjust the positions of the respective light modulation devices corresponding to the respective colors relative to a color combining device and the projection optical device. In addition, it is necessary to appropriately adjust the positions of the respective light modulation devices corresponding to the respective colors relative to one another.

Patent Document 1 (JP-2000-227634) discloses a positioning method of light values, a display unit, and a projection-type display apparatus that can position the light valves easily, promptly, and reliably by focus adjustment and position adjustment of the light valves based on an electronic image obtained by imaging a projection image projected on a screen. Patent Document 2 (JP-2007-47648) discloses manufacturing equipment of an optical apparatus, a manufacturing method thereof, and an optical apparatus that can reduce the manufacturing cost by including a six-axis position adjustment unit rotating device that rotates a six-axis position adjustment unit for position adjustment of light modulation devices, and performing position adjustment of the plural light modulation devices using one six-axis position adjustment unit.

However, in a projection apparatus that includes a reflective light valve (light modulation device) and converts electronic image information into optical image information using the light valve, light transmitted through a reflective polarizer is reflected by the reflective light valve and becomes light having the optical image information, and the light is reflected by the reflective light valve and guided to the projection optical device.

Accordingly, in the projection apparatus including the reflective light valve, it is necessary to position the reflective light valve and the reflective polarizer relative to the projection optical device and perform position adjustment of the reflective light valve and the reflective polarizer relative to each other. On this account, there is a problem that the adjustment of the projection apparatus including the reflective light valve is more complex than adjustment of a projection apparatus including a transmissive light valve and high-accuracy adjustment is difficult.

### SUMMARY

An advantage of some aspects of the invention is to solve at least a part of the problems described above and the invention may be implemented as the following embodiments or application examples.

### Application Example 1

This application example is directed to a manufacturing method of a projection apparatus including a reflective light modulation device that optically modulates an incident light and outputs a modulated light formed by the modulation of the incident light and a reflective polarizer that transmits the incident light output from a light source and reflects the modulated light toward a projection optical device, and includes a unit formation step of forming a modulation device unit having the reflective light modulation device and the reflective polarizer, the reflective light modulation device and the reflective polarizer fixed to predetermined relative positions, and a position adjustment step of adjusting a position of the reflective light modulation device relative to the projection optical device by shifting a position of the modulation device unit with respect to the projection optical device.

According to the manufacturing method of the projection apparatus according to this application example, at the unit formation step, the modulation device unit in which the reflective light modulation device and the reflective polarizer are fixed to the predetermined relative positions is formed. At the step, regardless of the positional relationship of the reflective light modulation device and the reflective polarizer with the projection optical device or the like, only the relative positions of the reflective light modulation device and the reflective polarizer may be positioned. Accordingly, the modulation device unit in which the reflective light modulation device and the reflective polarizer are provided in an appropriate positional relationship may easily be formed.

At the position adjustment step, the position of the reflective light modulation device is adjusted relative to the projection optical device by shifting the position of the modulation device unit. In the modulation device unit, the reflective light modulation device and the reflective polarizer are fixed to the predetermined relative positions, and the reflective light modulation device and the reflective polarizer may collectively be position-adjusted relative to the projection optical device.

### Application Example 2

It is preferable that the manufacturing method of the projection apparatus according to the application example, at the position adjustment step, performs six-axis adjustment and position adjustment in rotation directions around axes adjusts the positions in rotation directions around the respective axes of the three axes crossing one another at a center of the reflective light modulation device in a virtual image of the reflective light modulation device by the reflective polarizer.

According to the manufacturing method of the projection apparatus, at the position adjustment step, the position adjustment in the rotation directions around the axes is performed by adjusting the positions in the rotation directions around the three axes orthogonal to one another at the center of the reflective light modulation device in the virtual image of the reflective light modulation device by the reflective polarizer. The six-axis adjustment is adjustment of the positions in the respective axis directions of the three axes crossing one another and the positions (tilt angles) in the rotation directions around the respective axes.

The reflective light modulation device has an output surface of the modulated light and outputs the modulated light from an output region of the output surface. Inside the reflective light modulation device, a conversion part having a function of converting electronic information into optical information is formed. The modulated light is light formed by addition of the optical information corresponding to the electronic information. In the direction in parallel to the output surface, the conversion part is provided in a range corresponding to the output region. The projection optical device projects an image formed in a position in which the conversion part exists on a screen or the like. The center of the reflective light modulation device is a geometrical center position in the output region in the direction in parallel to the output surface and the position in which the conversion part exists in the direction perpendicular to the output surface.

The light output from the reflective light modulation device in the modulation device unit and projected by the projection optical device is equivalent to the light output from the reflective light modulation device existing in the position of the virtual image of the reflective light modulation device by the reflective polarizer and projected by the projection optical device. By moving the modulation device unit, the reflective light modulation device and the reflective polarizer integrally move, and the movement of the modulation device unit is the same as the movement of the virtual image of the reflective light modulation device by the reflective polarizer as seen from the projection optical device. Generally, by rotation around an axis passing through a center, the center does not move in an axis direction crossing the axis. Therefore, by adjusting the position in the rotation direction around the axis, the position in the axis direction crossing the axis may be suppressed. Accordingly, at the position adjustment step, by rotating the modulation device unit around three axes orthogonal to one another at the center of the reflective light modulation device in the virtual image of the reflective light modulation device by the reflective polarizer, displacement of the position in the axis direction crossing the rotational axis due to correction of the tilt of the reflective light modulation device may be suppressed. Since displacement of the positions in other directions due to adjustment around one axis may be suppressed, and thus, the amount of correction for correction of the displacement becomes smaller and the adjustment becomes easier, and the time taken for the adjustment may be suppressed.

### Application Example 3

This application example is directed to manufacturing equipment of a projection apparatus including a reflective light modulation device that optically modulates incident light and outputs a modulated light formed by the modulation of the incident light and a reflective polarizer that transmits the incident light output from a light source and reflects the modulated light toward a projection optical device, includes a unit retaining section of retaining a modulation device unit in which the reflective light modulation device and the reflective polarizer are fixed in a predetermined positional relationship, and a position adjustment section of adjusting a position of the reflective light modulation device relative to the projection optical device by shifting a position of the modulation device unit retained by the unit retaining section with respect to the projection optical device.

According to the manufacturing equipment of the projection apparatus according to this application example, the manufacturing equipment of the projection apparatus includes the unit retaining section that retains the reflective light modulation device and the reflective polarizer. In the modulation device unit, the reflective light modulation device and the reflective polarizer are fixed to predetermined relative positions. In the modulation device unit, regardless of the positional relationship of the reflective light modulation device and the reflective polarizer with the projection optical device or the like, only the relative positions of the reflective light modulation device and the reflective polarizer may be positioned. By including the unit retaining section, the modulation device unit in which the reflective light modulation device and the reflective polarizer are provided in an appropriate positional relationship may be retained.

The position adjustment section adjusts the position of the reflective light modulation device relative to the projection optical device by shifting the position of the modulation device unit. In the modulation device unit, the reflective light modulation device and the reflective polarizer are fixed to the predetermined relative positions, and the reflective light modulation device and the reflective polarizer may collectively be position-adjusted relative to the projection optical device.

### Application Example 4

It is preferable that, in the manufacturing equipment of the projection apparatus according to the application example, the position adjustment section performs six-axis adjustment, and three rotational axes at adjustment of rotation directions around axes cross one another at an adjustment center, and the unit retaining section retains the modulation device unit by positioning a center of the reflective light modulation device in a virtual image of the reflective light modulation device by the reflective polarizer at the adjustment center.

According to the manufacturing equipment of the projection apparatus, the position adjustment section adjusts the rotational positions around the axes with respect to the three axes crossing one another at the adjustment center. The unit retaining section retains the modulation device unit with the center of the reflective light modulation device in the virtual image of the reflective light modulation device by the reflective polarizer positioned on the adjustment center. Thereby, the position adjustment in the rotation directions around the axes is performed by adjusting the positions in the rotation directions around the three axes orthogonal to one another at the center of the reflective light modulation device in the virtual image of the reflective light modulation device by the reflective polarizer. The six-axis adjustment is adjustment of the positions in the respective axis directions of the three axes crossing one another and the positions (tilt angles) in the rotation directions around the respective axes.

The reflective light modulation device has an output surface of the modulated light and outputs the modulated light from an output region of the output surface. Inside the reflective light modulation device, a conversion part having a function of converting electronic information into optical information is formed. The modulated light is light formed by addition of the optical information corresponding to the electronic information. In the direction in parallel to the output surface, the conversion part is provided in a range corresponding to the output region. The projection optical device projects an image formed in a position in which the conversion part exists on a screen or the like. The center of the reflective light modulation device is a geometrical center position in the output region in the direction in parallel to the output surface and the position in which the conversion part exists in the direction perpendicular to the output surface.

The light output from the reflective light modulation device in the modulation device unit and projected by the projection optical device is equivalent to the light output from the reflective light modulation device existing in the position of the virtual image of the reflective light modulation device by the reflective polarizer and projected by the projection optical device. By moving the modulation device unit, the reflective light modulation device and the reflective polarizer integrally move, and the movement of the modulation device unit is the same as the movement of the virtual image of the reflective light modulation device by the reflective polarizer as seen from the projection optical device. Generally, by rotation around an axis passing through a center, the center does not move in an axis direction crossing the axis. Therefore, by adjusting the position in the rotation direction around the axis, the position in the axis direction crossing the axis may be suppressed. Accordingly, the position adjustment section rotates the modulation device unit around three axes orthogonal to one another at the center of the reflective light modulation device in the virtual image of the reflective light modulation device by the reflective polarizer, and thereby, displacement of the position in the axis direction crossing the rotational axis due to correction of the tilt of the reflective light modulation device may be suppressed. Since displacement of the positions in other directions due to adjustment around one axis may be suppressed, and thus, the amount of correction for correction of the displacement becomes smaller and the adjustment becomes easier, and the time taken for the adjustment may be suppressed.

### Application Example 5

A projection apparatus according to this application example includes a reflective light modulation device that optically modulates incident light and outputs a modulated light formed by the modulation of the incident light, a reflective polarizer that transmits the incident light output from a light source and reflects the modulated light toward a projection optical device, a modulation device frame to which the reflective light modulation device and the reflective polarizer are fixed and in which a positional relationship between the reflective light modulation device and the reflective polarizer is maintained in a predetermined positional relationship by the fixation, and an adjustment support section that may position-adjusts the modulation device frame relative to the projection optical device and fixably supports the positions of the reflective light modulation device and the reflective polarizer fixed to the modulation device frame relative to the projection optical device by a fixing section.

According to the projection apparatus according to this application example, the projection apparatus includes the modulation device frame, and the positional relationship between the reflective light modulation device and the reflective polarizer is maintained in the predetermined positional relationship by the fixation to the modulation device frame. Only by fixing the reflective light modulation device and the reflective polarizer to the modulation device frame, the unit in which the reflective light modulation device and the reflective polarizer are provided in an appropriate positional relationship may easily be formed.

The adjustment support section may position-adjusts the modulation device frame relative to the projection optical device and fixably supports it by the fixing section. Since the reflective light modulation device and the reflective polarizer are fixed to the modulation device frame in the appropriate positional relationship, and the reflective light modulation device and the reflective polarizer may collectively be position-adjusted and fixed relative to the projection optical device.

### Application Example 6

It is preferable that, in the projection apparatus according to the application example, the adjustment support section rotatably supports the modulation device frame around three axes orthogonal to one another at a center of the reflective light modulation device in a virtual image of the reflective light modulation device by the reflective polarizer in a state in which the section is not fixed by the fixing section.

According to the projection apparatus, the adjustment support section rotatably supports the modulation device frame around three axes orthogonal to one another at the center of the reflective light modulation device in the virtual image of the reflective light modulation device by the reflective polarizer. When the position of the reflective light modulation device is adjusted relative to the projection optical device, the adjustment may be performed by adjusting the positions in the rotation directions around the three axes orthogonal to one another with the modulation device frame to which the reflective light modulation device is fixed at the center of the reflective light modulation device in the virtual image of the reflective light modulation device by the reflective polarizer.

The reflective light modulation device has an output surface of the modulated light and outputs the modulated light from an output region of the output surface. Inside the reflective light modulation device, a conversion part having a function of converting electronic information into optical information is formed. The modulated light is light formed by addition of the optical information corresponding to the electronic information. In the direction in parallel to the output surface, the conversion part is provided in a range corresponding to the output region. The projection optical device projects an image formed in a position in which the conversion part exists on a screen or the like. The center of the reflective light modulation device is a geometrical center position in the output region in the direction in parallel to the output surface and the position in which the conversion part exists in the direction perpendicular to the output surface.

The light output from the reflective light modulation device, reflected by the reflective polarizer, and projected by the projection optical device is equivalent to the light output from the reflective light modulation device existing in the position of the virtual image of the reflective light modulation device by the reflective polarizer and projected by the projection optical device. By moving the modulation device unit, the reflective light modulation device and the reflective polarizer fixed to the modulation device frame integrally move, and the movement of the modulation device unit is the same as the movement of the virtual image of the reflective light modulation device by the reflective polarizer as seen from the projection optical device. Generally, by rotation around an axis passing through a center, the center does not move in an axis direction crossing the axis. Therefore, by adjusting the position in the rotation direction around the axis, the position in the axis direction crossing the axis may be suppressed. Accordingly, by rotating the modulation device frame around three axes orthogonal to one another at the center of the reflective light modulation device in the virtual image of the reflective light modulation device by the reflective polarizer, displacement of the position in the axis direction crossing the rotational axis due to correction of the tilt of the reflective light modulation device may be suppressed. Since displacement of the positions in other directions due to adjustment around one axis may be suppressed, and thus, the amount of correction for correction of the displacement becomes smaller and the adjustment becomes easier, and the time taken for the adjustment may be suppressed.

### Application Example 7

It is preferable that, in the projection apparatus according to the application example, the adjustment support section is provided in a position in which one axis of the three axes crossing one another through the center of the reflective light modulation device in the virtual image of the reflective light modulation device by the reflective polarizer penetrates the adjustment support section.

According to the projection apparatus, the adjustment support section is provided in the position in which one axis of the three axes crossing one another through the center of the reflective light modulation device penetrates the adjustment support section. Thereby, the amount of shift of the adjustment support section in the direction crossing the axis at the adjustment of the rotational position around the axis may be suppressed.

### BRIEF DESCRIPTION OF THE DRAWINGS

The invention will be described with reference to the accompanying drawings, wherein like numbers reference like elements.

FIG. 1 is a schematic diagram showing an outline configuration of a projector.

FIG. 2A is an exploded perspective view showing a configuration of a light modulation unit and an adjustment member, and FIG. 2B is a perspective view showing a positional relationship between the adjustment member and a cross dichroic prism.

FIG. 3A is a plan view showing an outline configuration of a light modulation device, FIG. 3B is a side view showing the outline configuration of the light modulation device, and FIG. 3C is a schematic sectional view showing a section shape in a section shown by A-A in FIG. 3A.

FIG. 4A is a schematic side view showing an overall configuration of a modulation device position adjuster, and

FIG. 4B is a schematic plan view showing the overall configuration of the modulation device position adjuster.

FIG. 5 is a schematic side view showing an overall configuration of a six-axis position adjustment unit.

FIG. 6A is a schematic side view showing a configuration of a retainer, an in-plane rotational position adjustment part, and a plane tilt adjustment part, and FIG. 6B is a schematic plan view showing the configuration of the retainer, the in-plane rotational position adjustment part, and the plane tilt adjustment part.

FIG. 7 is a flowchart showing steps of position-adjusting a reflective liquid crystal panel relative to a projection lens.

### DESCRIPTION OF EXEMPLARY EMBODIMENTS

Hereinafter, a manufacturing method of a projection apparatus, manufacturing equipment of the projection apparatus, and a projection apparatus will be described with reference to the drawings. In the embodiment, a projector that displays a color image by optically combining optical image information of three colors and radiating it and steps of manufacturing the projector will be explained as an example. Note that, in the respective drawings referred to, the ratio of dimensions of the respective component elements and the like will be differed appropriately for easy-to-understand illustration of the configuration.

### Projector

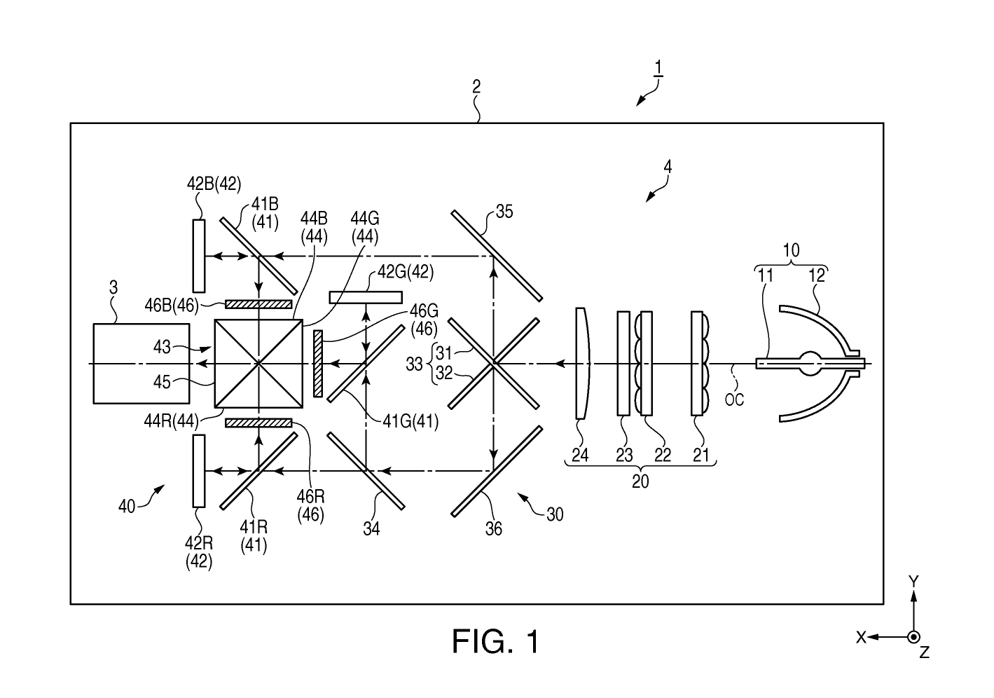

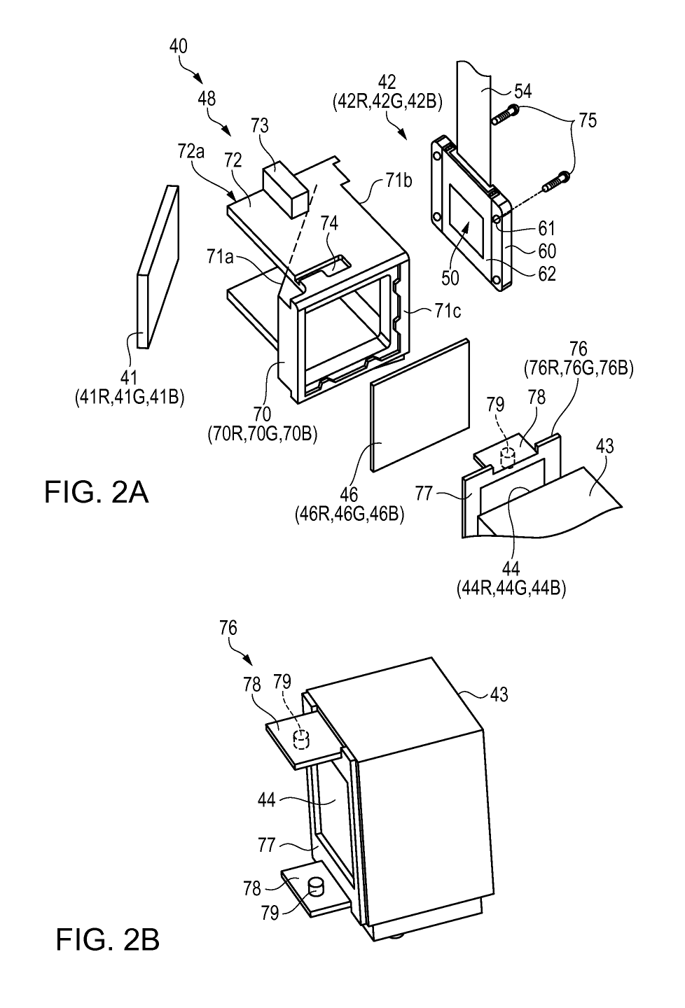

First, a projector 1 will be explained with reference to FIGS. 1, 2A, and 2B. FIG. 1 is a schematic diagram showing an outline configuration of the projector. FIGS. 2A and 2B are exploded perspective views showing a configuration of an optical device. FIG. 2A is an exploded perspective view showing a configuration of a light modulation unit and an adjustment member, and FIG. 2B is a perspective view showing a positional relationship between the adjustment member and a cross dichroic prism. The projector 1 corresponds to a projection apparatus.

As shown in FIG. 1, the projector 1 includes a case 2, a projection lens 3, and an optical unit 4. An illumination optical axis OC is a center axis of luminous flux output from a light source device 10. The projector 1 modulates light output from the light source device 10 in response to image information and enlarges and projects it on a projection surface such as a screen.

The axis direction of the illumination optical axis OC is represented by the X-axis direction, the axis direction nearly orthogonal to the X-axis direction and in parallel to the paper surface in FIG. 1 is represented by the Y-axis direction, and the axis direction nearly orthogonal to the X-axis direction and the Y-axis direction (the axis direction perpendicular to the paper surface in FIG. 1) is represented by the Z-axis direction. The projection lens 3 corresponds to a projection optical device.

Though not shown, the projector 1 further includes a cooling fan that cools the respective component members within the projector 1, a power supply that supplies power to the respective component members within the projector 1, and a controller that integrally controls the respective devices of the projector 1. The cooling fan, the power supply, and the controller are provided in a space other than the projection lens 3 and the optical unit 4 within the case 2.

The projection lens 3 and the optical unit 4 are positioned relative to the illumination optical axis OC and fixed to the case 2. The projection lens 3 is a combined lens formed by combining plural lenses, and enlarges and projects the luminous flux modulated by the optical unit 4 on a projection surface such as a screen. The optical unit 4 is a unit that optically process the luminous flux output from the light source in response to image signals. The optical unit 4 includes the light source device 10, an illumination optical device 20, a color separation optical device 30, and an optical device 40.

The light source device 10 includes a light source lamp 11 and a reflector 12. In the light source device 10, the output directions of the luminous fluxes output from the light source lamp 11 are aligned and output toward the illumination optical device 20.

The illumination optical device 20 includes a first lens array 21, a second lens array 22, a polarization conversion element 23, and a superimposing lens 24. The first lens array 21 divides the luminous flux output from the light source device 10 into plural partial luminous fluxes. The second lens array 22 collects the plural partial luminous fluxes divided by the first lens array 21. The polarization conversion element 23 outputs the respective partial luminous fluxes from the second lens array 22 as nearly one linearly-polarized light in the aligned polarization directions. The superimposing lens 24 superimposes the plural partial luminous fluxes output as the linearly-polarized light from the polarization conversion element 23 on the surfaces of reflective liquid crystal panels 50 (see FIG. 2A) of three light modulation devices 42.

The color separation optical device 30 includes a cross dichroic mirror 33 in which a dichroic mirror 31 that reflects blue light and a dichroic mirror 32 that reflects green light and red light arranged in an X-shape, a dichroic mirror 34 that reflects green light, and two reflection mirrors 35, 36. The color separation optical device 30 separates the respective plural partial luminous fluxes output from the illumination optical device 20 into color lights of three colors of red, green, blue.

The blue light separated by the cross dichroic mirror 33 is reflected by the reflection mirror 35 and enters a wire grid 41B of the optical device 40. Further, the green light and the red light separated by the cross dichroic mirror 33 are reflected by the reflection mirror 36, and then, enters the dichroic mirror 34. The green light is reflected by the dichroic mirror 34 and enters a wire grid 41G of the optical device 40. On the other hand, the red light is transmitted through the dichroic mirror 34 and enters a wire grid 41R of the optical device 40.

The optical device 40 modulates the entering luminous fluxes in response to image information. The optical device 40 includes a head body (not shown), three wire grids 41 (41R, 41G, 41B), three light modulation devices 42 (42R, 42G, 42B), a cross dichroic prism 43, and three polarizers 46 (46R, 46G, 46B).

A set of the wire grid 41, the light modulation device 42, and the polarizer 46 is represented by a modulation device unit 48. The optical device 40 includes three of the modulation device unit 48R, the modulation device unit 48G, and the modulation device unit 48B that modulate red light, green light, and the blue light.

Note that, in the specification, regarding the devices and members provided with respect to each color light of the three colors of red, green, blue like as the three wire grids 41, R, G, B are respectively assigned to the end of the signs for indicating correspondences with the respective colors. Further, in the common explanation for the respective colors, R, G, B may not be assigned to the end of the signs.

The head body is fixed to the case 2. Onto the head body, the cross dichroic prism 43 is mounted and fixed, and the projection lens 3 is supported. The respective optical components of the optical devices 40 are positioned relative to the projection lens 3 and mounted and fixed onto the head body. The respective optical components of the optical devices 40 and the projection lens 3 are positioned relative to the illumination optical axis OC because the head body is fixed to the case 2.

Each wire grid 41 is provided at a tilt of about 45° relative to the optical axis of the entering luminous flux. The wire grid 41 polarization-separates the entering luminous flux by transmitting polarized lights having the same polarization direction as the polarization direction of the polarization conversion element 23 and reflecting polarized lights having an orthogonal polarization direction. The wire grid 41 corresponds to a reflective polarizer.

Each light modulation device 42 is a reflective light modulation device, and includes the reflective liquid crystal panel 50 as a reflective light modulation device and a holding frame 60 (see FIG. 2A) that holds the reflective liquid crystal panel 50. Each reflective liquid crystal panel 50 modulates the polarization direction of the polarized luminous flux transmitted through each wire grid 41 and reflects it toward each wire grid 41. Of the luminous flux modulated by the reflective liquid crystal panel 50 and reflected toward each wire grid 41, only the polarized light orthogonal to the polarization direction aligned by the polarization conversion element 23 is reflected by the wire grid 41. Note that the detailed configuration of the light modulation device 42 will be described later.

Each polarizer 46 is provided to face each luminous flux incident-side end surface 44 (44R, 44G, 44B) of the cross dichroic prism 43, respectively, and transmits the linearly-polarized light in the same direction as the polarization direction reflected by each wire grid 41.

The cross dichroic prism 43 combines the respective color lights reflected by the respective wire grids 41 and entering the respective luminous flux incident-side end surfaces 44, and outputs the light from a luminous flux exiting-side end surface 45. The cross dichroic prism 43 has a nearly square shape in a plan view formed by bonding four right angle prisms, and two dielectric multilayer films are formed on interfaces between the bonded angle prisms. These dielectric multilayer films transmit green light reflected by the wire grid 41G and reflect red and blue lights reflected by the wire grids 41R, 41B, respectively. In this manner, the respective color lights modulated by the respective reflective liquid crystal panels 50 are combined by the cross dichroic prism 43, and enlarged and projected on the projection surface by the projection lens 3.

As shown in FIG. 2A, the optical device 40 further includes adjustment members 76, and the modulation device units 48 further includes an attachment member 70. In FIGS. 2A and 2B, one modulation device unit 48 is shown, and one attachment member 70 and the respective parts attached to the attachment member 70 are illustrated. The optical device 40 includes the modulation device units 48 provided for the respective three colors, and includes the three attachment members 70 (70R, 70G, 70B) and the three adjustment members 76 (76R, 76G, 76B) provided for the respective three colors. All of the attachment members 70 corresponding to the color lights of the three color lights and the attached respective parts have the same configurations as that shown in FIGS. 2A and 2B.

The configuration of the attachment member 70 shown in FIGS. 2A and 2B corresponds to the wire grid 41R that has been explained with reference to FIG. 1. The directions of the tilts of the wire grid 41G and the wire grid 41B relative to the luminous flux incident-side end surfaces 44 are opposite to the direction of the tilt of the wire grid 41R relative to the luminous flux incident-side end surface 44. It is necessary that the positions of the wire grid 41 and the light modulation device 42 in the plan view with respect to the polarizer 46 are inverted between the case where the wire grid 41R is fixed to the attachment member 70 and the case where the wire grid 41G or the wire grid 41B is fixed to the member. The attachment member 70 has a vertical symmetric shape, and the positions of the wire grid 41 and the light modulation device 42 are inversed by turning the attachment member 70 upside down, and the optical device 40 having the same configuration may be formed.

The attachment member 70 has a shape formed by attaching nearly rectangular top plates 72 to upper and lower nearly triangular parts in a hollow member having a nearly triangular prism shape, and integrally formed using a synthetic resin, for example. The triangular prism shape part in the attachment member 70 includes a first side surface 71a as an inclined surface, and a second side surface 71b and a third side surface 71c with an apex angle in between. Opening parts are formed in the respective side surfaces of the first side surface 71a, the second side surface 71b, and the third side surface 71c. The attachment member 70 is provided with the third side surface 71c facing the adjustment member 76. On the upper and lower parts of the triangular prism shape part, the top plates 72 are integrally formed. Two sides of the nearly rectangular shapes of the top plates 72 are along the second side surface 71b or the third side surface 71c and project toward the first side surface 71a side. On the end surfaces projecting toward the first side surface 71a side, contact surfaces 72a nearly in parallel to the third side surface are formed.

On the top plates 72 as the top surface and the bottom surface of the attachment member 70, engagement grooves 74 and grip lugs 73 are respectively formed. The engagement groove 74 is a concave groove formed nearly at the center of the width of the third side surface 71c near the end at the third side surface 71c on the top plate 72. The grip lug 73 is a plate-like lug stood on the surface of the top plate 72 and extends in a direction in parallel to the second side surface 71b in a position nearly at the center of the third side surface 71c in the planar direction of the third side surface 71c. The grip lug 73 has a length in the direction in parallel to the second side surface 71b of about ⅓ of the width of the second side surface 71b in the direction, and its one end surface is nearly in the same plane as the contact surface 72a.

To the first side surface 71a, the wire grid 41 is fixed by bonding or the like. On the second side surface 71b, the light modulation device 42 is provided with its luminous flux incident-side directed toward the second side surface 71b and fixed using screws 75 through screw holes 61. On the third side surface 71c, the polarizer 46 is fixed by bonding or the like. The wire grid 41, the light modulation device 42, and the polarizer 46 are respectively fixed to the attachment member 70, and thereby, arranged in the positional relationship relative to one another, which has been described with reference to FIG. 1. The attachment member 70 corresponds to a modulation device frame. The modulation device unit 48 corresponds to a modulation device unit.

As shown in FIG. 2B, the adjustment member 76 includes a main body 77 and arm parts 78, and attached to the luminous flux incident-side end surface 44 of the cross dichroic prism 43 by bonding or the like. A pair of the arm parts 78 are provided from the upper part and the lower part of the main body 77 toward the attachment member 70 side and have engagement protrusions 79 at the ends thereof. The engagement protrusions 79 are loosely fitted in the engagement grooves 74, and thereby, the attachment member 70 is attached to the adjustment member 76. By injecting an adhesive into parts in which the engagement protrusions 79 are loosely fitted in the engagement grooves 74 and curing it, the engagement protrusions 79 are bonded and fixed to the engagement grooves 74. Thereby, the modulation device unit 48 is fixed to a predetermined position relative to the luminous flux incident-side end surface 44 of the cross dichroic prism 43. That is, the wire grid 41, the light modulation device 42, and the polarizer 46 are fixed to predetermined positions relative to the projection lens 3. The sets of the engagement protrusion 79 and the engagement groove 74 correspond to an adjustment support section. The adhesive that bonds and fixes the engagement protrusion 79 to the engagement groove 74 corresponds to a fixing section.

### Light Modulation Device

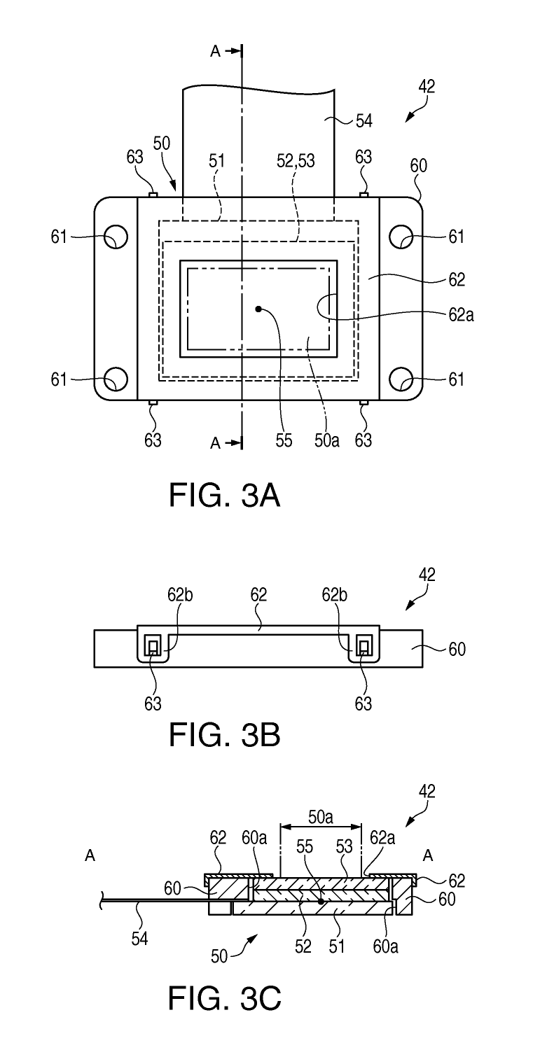

Next, the configuration of the light modulation device will be explained with reference to FIGS. 3A to 3C. FIGS. 3A to 3C show the outline configuration of the light modulation device. FIG. 3A is a plan view showing an outline configuration of the light modulation device, FIG. 3B is a side view showing the outline configuration of the light modulation device, and FIG. 3C is a schematic sectional view showing a section shape in a section shown by A-A in FIG. 3A. As shown in FIGS. 3A to 3C, the light modulation device 42 includes the reflective liquid crystal panel 50, a dustproof glass 53, the holding frame 60, and a light-blocking plate 62.

The reflective liquid crystal panel 50 is the so-called LCOS (Liquid Crystal On Silicon) in which a liquid crystal layer is formed on a silicon substrate. The reflective liquid crystal panel 50 has a device substrate 51 and an opposed substrate 52 having nearly rectangular shapes, and a liquid crystal layer formed by air-tightly sealing liquid crystal as an electro-optic material between the device substrate 51 and the opposed substrate 52.

On the device substrate 51, various wires of scan lines and data lines crossing one another etc., pixel electrodes arranged in a matrix or the like in response to the crossings of the scan lines and the data lines, and TFTs (Thin Film Transistors) electrically connected to the data lines, the scan lines, and the pixel electrodes are provided. The pixel electrodes are provided in an image display region 50a, lights entering the image display region 50a are modulated based on image data, and the modulated lights are output.

By applying voltages to the pixel electrodes using the TFTs to operate the liquid crystal located in the position facing the pixel electrodes, the lights transmitted through the parts are controlled. By controlling the lights transmitted through the parts of the respective pixel electrodes based on the image data, pixels corresponding to the image data are formed in the reflective liquid crystal panel 50, and an image as a collection of pixels is formed. The position of the liquid crystal layer as a part in which the image is formed, the position superimposed on the center of the image display region 50a having the nearly rectangular shape is represented by a panel center 55.

On the opposed substrate 52, a common electrode for generation of an electric field between the pixel electrodes and itself and a black matrix that sections the regions of the respective pixels are provided. The planar size of the device substrate 51 is slightly larger than the planar size of the opposed substrate 52, and a connection terminal part for electric connection to the controller is formed on one end of the device substrate 51.

To the connection terminal part of the device substrate 51, a flexible printed board 54 is electrically connected and fixed. Via the flexible printed board 54, a drive signal from the controller is input to the reflective liquid crystal panel 50. The reflective liquid crystal panel 50, with its orientation state of the liquid crystal controlled in response to the drive signal from the controller, modulates the polarization direction of the polarized luminous flux entering from the opposed substrate 52 side and outputs it from the opposed substrate 52 side. In the light modulation device 42 (reflective liquid crystal panel 50), the opposed substrate 52 side is referred to as “incident side” and the device substrate 51 side is referred to as “rear side”.

The holding frame 60 holds the reflective liquid crystal panel 50 and is attached to the attachment member 70 (see FIGS. 2A and 2B). The holding frame 60 is formed in a nearly rectangular parallel piped shape using a metal material such as a magnesium alloy or an aluminum alloy, a heat-resistant synthetic resin, or the like. The holding frame 60 has an opening part 60a for containing the reflective liquid crystal panel 50 and the dustproof glass 53 nearly at the center, screw holes 61 for attachment to the attachment member 70 in the four corners, and hooks 63 for fixing the light-blocking plate 62 on the side surfaces. Further, the part of the holding frame 60 in which the flexible printed board 54 is provided is cut out.

The reflective liquid crystal panel 50 (the device substrate 51 and the opposed substrate 52) is contained within the opening part 60a and fixed to the holding frame 60 by bonding or the like. The dustproof glass 53 is contained within the opening part 60a and fixed to the surface of the opposed substrate 52 by bonding or the like. The dustproof glass 53 is made of quartz glass, sapphire, crystal, or the like. The dustproof glass 53 prevents dust from adhering to the incident-side surface of the opposed substrate 52. Further, even when dust adheres to the surface of the dustproof glass 53, the dust is located in a position off from the focal position and the shadow of the dust in the projected image light is hardly noticeable.

The light-blocking plate 62 is provided in contact with the surface of the dustproof glass 53 at the incident side of the holding frame 60. The light-blocking plate 62 is formed using a nearly rectangular plate material by sheet-metal processing or the like. The light-blocking plate 62 is made of a material having a coefficient of thermal conductivity equal to or more than the coefficient of thermal conductivity of the material forming the holding frame 60, and includes a metal material such as an aluminum alloy, copper, or the like.

The light-blocking plate 62 has an opening part 62a provided in a plate-like part nearly in parallel to the dustproof glass 53, and hook engagement parts 62b extending from the plate-like part around to the side surfaces provided with the hooks 63 of the holding frame 60. The opening part 62a is provided to be superimposed on the image display region 50a in which the pixel electrodes are arranged in the reflective liquid crystal panel 50. The light-blocking plate 62 is fixed to the holding frame 60 when the hook engagement parts 62b are engaged with the hooks 63. The reflective liquid crystal panel 50 corresponds to a reflective light modulation device.

### Modulation Device Position Adjuster

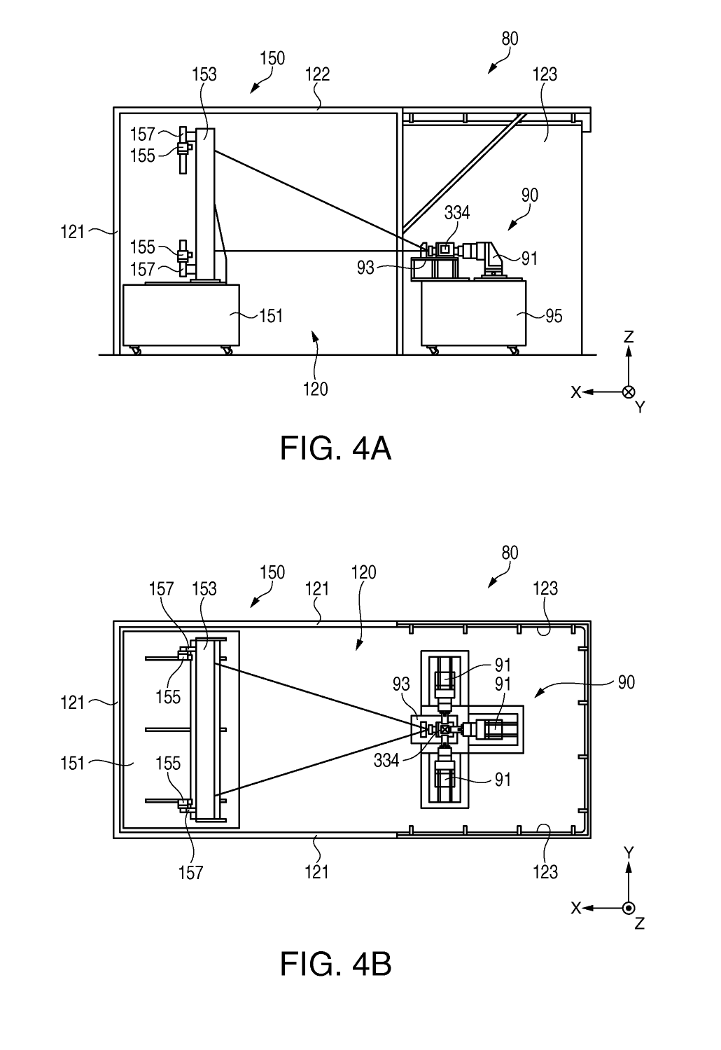

Next, a modulation device position adjuster 80 will be explained with reference to FIGS. 4A, 4B, 5, 6A, and 6B. The modulation device position adjuster 80 is a device that performs steps of position-adjusting and fixing the light modulation device 42 (reflective liquid crystal panel 50) relative to the projection lens 3. As described above, the light reflected by the reflective liquid crystal panel 50 and output is reflected by the wire grid 41 and enters the projection lens 3 via the cross dichroic prism 43. The unit in which the cross dichroic prism 43 and the projection lens 3 are mounted and fixed to the above described head body is referred to as “projection optical unit 334”. In the projection optical unit 334, the luminous flux incident-side end surface 44 of the cross dichroic prism 43 is fixed at a right angle relative to the optical axis of the projection lens 3 based on the design, and fixed to a fixed position relative to the focal position of the projection lens 3. The modulation device position adjuster 80 performs steps of position-adjusting and fixing the light modulation device 42 (reflective liquid crystal panel 50) relative to the projection lens 3 by position-adjusting and fixing the modulation device unit 48 relative to the projection optical unit 334. This may be described in other words that the modulation device position adjuster 80 position-adjusts the reflective liquid crystal panel 50 relative to the projection lens 3 by position-adjusting the modulation device unit 48 relative to the luminous flux incident-side end surface 44 of the cross dichroic prism 43. The modulation device position adjuster 80 corresponds to manufacturing equipment of the projection apparatus.

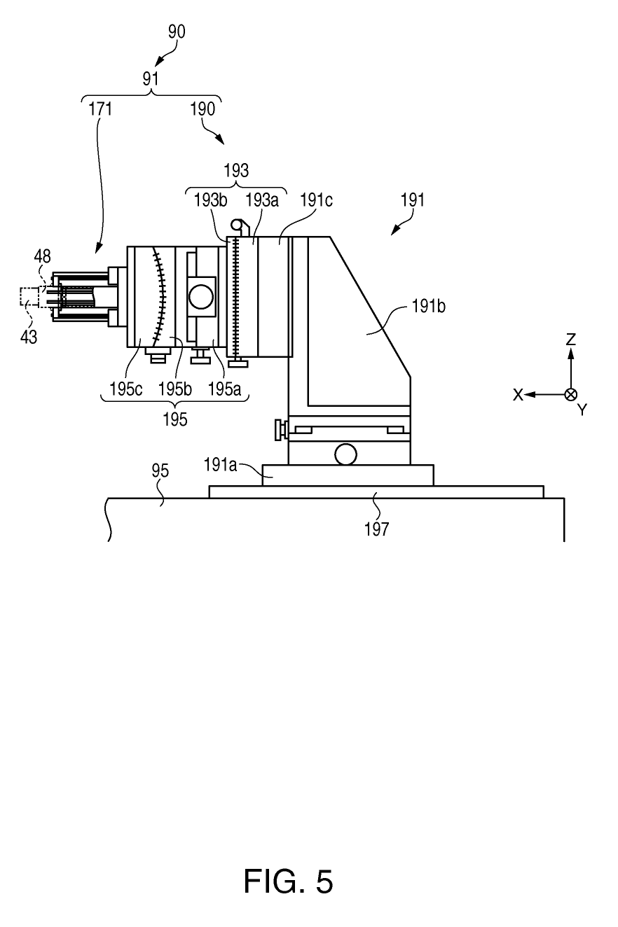

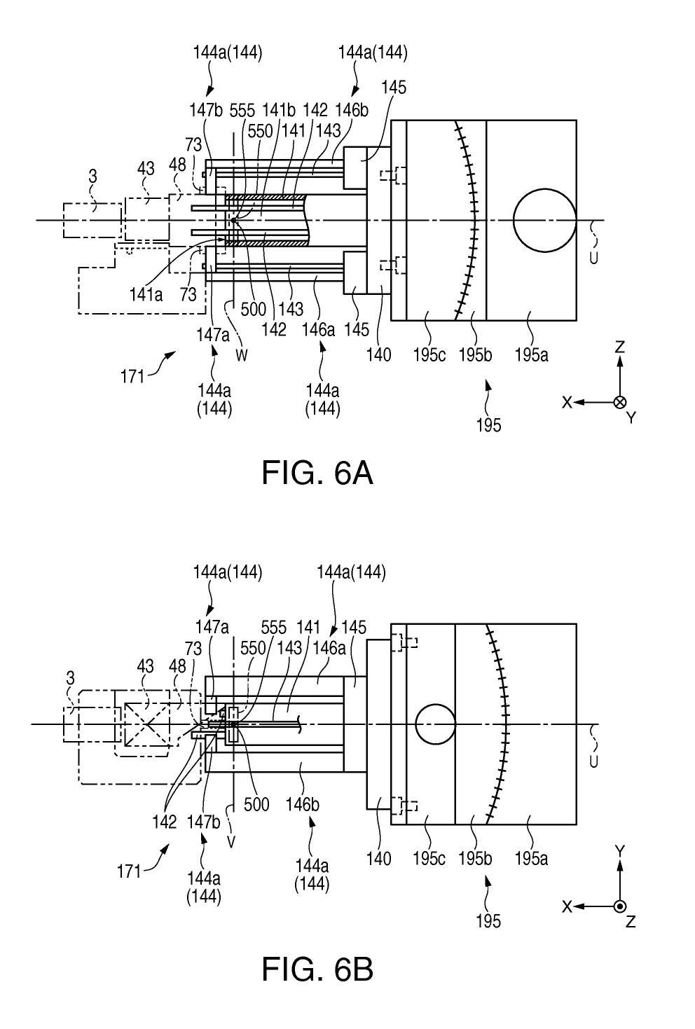

FIGS. 4A and 4B are schematic diagrams showing an overall configuration of the modulation device position adjuster. FIG. 4A is a schematic side view showing the overall configuration of the modulation device position adjuster, and FIG. 4B is a schematic plan view showing the overall configuration of the modulation device position adjuster. FIG. 5 is a schematic side view showing an overall configuration of a six-axis position adjustment unit. FIGS. 6A and 6B are schematic diagrams showing a configuration of a retainer, an in-plane rotational position adjustment part, and a plane tilt adjustment part in the six-axis position adjustment unit. FIG. 6A is a schematic side view showing the configuration of the retainer, the in-plane rotational position adjustment part, and the plane tilt adjustment part, and FIG. 6B is a schematic plan view showing the configuration of the retainer, the in-plane rotational position adjustment part, and the plane tilt adjustment part.

The X-axis direction, the Y-axis direction, and the Z-axis direction shown in FIGS. 4A and 4B are the same as the X-axis direction, the Y-axis direction, and the Z-axis direction shown in FIG. 1 in a state in which the projection optical unit 334 is fixed to the modulation device position adjuster 80. In the projection optical unit 334 fixed to the modulation device position adjuster 80, the optical axis direction of the projection lens 3 is the X-axis direction.

The X-axis direction, the Y-axis direction, and the Z-axis direction shown in FIGS. 5, 6A, and 6B are the same as the X-axis direction, the Y-axis direction, and the Z-axis direction shown in FIG. 1 in the case of a six-axis position adjustment unit 91 that performs position adjustment of the modulation device unit 48G of the three six-axis position adjustment units 91 shown in FIG. 4B.

As shown in FIGS. 4A and 4B, the modulation device position adjuster 80 includes an adjuster main body 90 and a screen unit 150, and is placed within a dark room 120.

The dark room 120 includes side boards 121 and a top board 122 surrounding the screen unit 150 and a light-shielding curtain 123 surrounding the adjuster main body 90. It is preferable to perform focus adjustment and alignment adjustment of the reflective liquid crystal panel 50 in a dark place like the dark room 120.

The screen unit 150 includes a pedestal 151, a transmissive screen 153, CCD cameras 155, and shift mechanisms 157.

The transmissive screen 153 includes a rectangular frame body provided around and a screen main body provided inside the frame body, and is stood on the pedestal 151. When the focus and alignment adjustment of the reflective liquid crystal panel 50 is performed, an image for adjustment is projected onto the transmissive screen 153. The projection surface of the screen main body of the transmissive screen 153 faces right in front of the adjuster main body 90.

The CCD cameras 155 are area sensors using charge coupled devices, as image sensing devices, for example, and detects and outputs a projection image formed on the screen main body as electric signals at the rear side of the screen main body. The screen unit 150 has four CCD cameras 155, and they are respectively provided nearly in the four corners of the screen main body having the nearly rectangular shape. The CCD cameras 155 are movably supported relative to the transmissive screen 153 via the shift mechanisms 157.

The shift mechanisms 157 have base parts, shirt axes, and camera mount parts. The base parts are fixed to the vicinities of the four corner parts of the frame body of the transmissive screen 153. The shift axes are provided slidably in a direction as a nearly horizontal direction nearly in parallel to the projection surface of the screen main body for the respective base parts. The camera mount parts are provided on the respective shift axes slidably in a direction as a nearly vertical direction nearly in parallel to the projection surface of the screen main body. The CCD cameras 155 are fixed to the camera mount parts. The camera mount parts are shifted in a planar direction in parallel to the projection surface of the screen main body by a servo control mechanism, and thereby, an imaging region of the CCD cameras 155 may be shifted. According to control information of the servo control mechanism, the position of the imaging region of the CCD cameras 155 on the screen main body may be specified.

The adjuster main body 90 includes the three six-axis position adjustment units 91, a clamp jig 93, a pedestal 95, a computer (not shown), an adjustment light source unit (not shown), and a fixation light source unit (not shown).

The clamp jig 93 supports and fixes the projection optical unit 334 onto the adjuster main body 90. The six-axis position adjustment unit 91 grasps and position-adjusts the modulation device unit 48 relative to the projection optical unit 334 supported and fixed to the clamp jig 93, and thereby, performs focus adjustment and alignment adjustment of the modulation device unit 48 (reflective liquid crystal panel 50) relative to the projection lens 3. The three six-axis position adjustment units 91 and the clamp jig 93 are mounted on the pedestal 95.

The computer controls the adjuster main body 90 and the screen unit 150. The adjustment light source unit introduces an adjustment light source when adjustment operation of the reflective liquid crystal panel 50 as an adjustment target is performed. The fixation light source unit supplies an ultraviolet ray for curing an ultraviolet curing adhesive when the engagement protrusions 79 are bonded and fixed to the engagement grooves 74. The computer, the adjustment light source unit, and the fixation light source unit are provided in the lower part of the pedestal 95.

As shown in FIG. 5, the six-axis position adjustment unit 91 includes a position adjustment mechanism main body 190 and a retainer 171. The six-axis position adjustment unit 91 position-adjusts the modulation device unit 48 relative to the projection optical unit 334 in six axis directions, and fixes the unit in a position-adjusted positional relationship. The retainer 171 retains the modulation device unit 48, and the position adjustment mechanism main body 190 position-adjusts the modulation device unit 48 relative to the projection optical unit 334 by position-adjusting the retainer 171 in the six axis directions. The six axis directions refer to positions in three axis directions of the X-axis direction, the Y-axis direction, and the Z-axis direction and rotational positions (tilt angles) around the respective axes of three axes of the X-axis, the Y-axis, or a U-axis, a V-axis, or a W-axis in parallel to the Z-axis. The position of the U-axis, the V-axis, or the W-axis will be described later.

The position adjustment mechanism main body 190 includes a planar position adjustment part 191, an in-plane rotational position adjustment part 193, and a plane tilt adjustment part 195. The retainer 171 is fixed to the end of the plane tilt adjustment part 195.

The planar position adjustment part 191 includes a base 191a, a Y-axis shift member 191b, and a Z-axis shift member 191c. The planar position adjustment part 191 has a function of adjusting the approach and retraction position of the modulation device unit 48 (reflective liquid crystal panel 50) relative to the luminous flux incident-side end surface 44 of the cross dichroic prism 43 and adjusting the position in the planar direction in parallel to the luminous flux incident-side end surface 44. By adjusting the position of the modulation device unit 48 in the planar direction in parallel to the luminous flux incident-side end surface 44, the position of the reflective liquid crystal panel 50 in the planar direction in parallel to the luminous flux incident-surface of the opposed substrate 52 of the design-based reflective liquid crystal panel 50 is adjusted.

The base 191a is slidable using a drive motor (not shown) while being guided by an X-axis rail 197 fixed to the pedestal 95, and retainably supported in an arbitrary position by the pedestal 95. The X-axis rail 197 extends in the X-axis direction and the base 191a is slidable in the X-axis direction and retainably supported in an arbitrary position. The Y-axis shift member 191b is slidable in the Y-axis direction using a drive motor (not shown) and retainably supported in an arbitrary position by the base 191a. The Z-axis shift member 191c is slidable in the Z-axis direction using a drive motor (not shown) and retainably supported in an arbitrary position by the Y-axis shift member 191b.

The in-plane rotational position adjustment part 193 includes a base 193a and a rotating member 193b. The in-plane rotational position adjustment part 193 has a function of performing adjustment of the rotational position of the modulation device unit 48 (reflective liquid crystal panel 50) within a plane in parallel to the luminous flux incident-side end surface 44 of the cross dichroic prism 43. By performing the adjustment of the rotational position of the modulation device unit 48 within the plane in parallel to the luminous flux incident-side end surface 44 of the cross dichroic prism 43, adjustment of the rotational position of the reflective liquid crystal panel 50 within the plane in parallel to the luminous flux incident-surface of the opposed substrate 52 of the design-based reflective liquid crystal panel 50 is performed.

The base 193a is fixed to the Z-axis shift member 191c. Thereby, the base 193a is movable in the X-axis direction, the Y-axis direction, and the Z-axis direction and retainably supported in an arbitrary position by the planar position adjustment part 191.

The base 193a and the rotating member 193b have nearly cylindrical shapes with a center axis in common. The center axis is the above described U-axis. The rotating member 193b is rotatable around the center axis (U-axis) using a rotating motor (not shown), and retainably supported in an arbitrary position by the base 193a. To position-adjust and fix the modulation device unit 48, the projection optical unit 334 fixed to the modulation device position adjuster 80 is fixed to a position in which the optical axis of the projection lens 3 in the projection optical unit 334 is aligned with the rotational axis of the rotating member 193b.

As shown in FIGS. 5, 6A, and 6B, the plane tilt adjustment part 195 includes a base 195a, a first adjustment member 195b, and a second adjustment member 195c. The plane tilt adjustment part 195 has a function of performing adjustment of the tilt of the modulation device unit 48 (reflective liquid crystal panel 50) relative to the plane in parallel to the luminous flux incident-side end surface 44 of the cross dichroic prism 43. By performing the adjustment of the tilt of the modulation device unit 48 relative to the plane in parallel to the luminous flux incident-side end surface 44, adjustment for correcting the tilt of the reflective liquid crystal panel 50 relative to the luminous flux incident-surface of the opposed substrate 52 of the design-based reflective liquid crystal panel 50 is performed.

The base 195a is fixed to the rotating member 193b. Thereby, the base 195a is rotatable around the U-axis as the rotational axis of the in-plane rotational position adjustment part 193 and retainably supported in an arbitrary position by the in-plane rotational position adjustment part 193. Further, the base is movable in the X-axis direction, the Y-axis direction, and the Z-axis direction and retainably supported in an arbitrary position by the planar position adjustment part 191.

The surface opposite to the surface fixed to the rotating member 193b in the base 195a is formed in a concave curved surface as a circular arc in a plane perpendicular to the Z-axis direction. The axis passing through the center of the circular arc in parallel to the Z-axis is the above described W-axis. The base 195a is fixed to a position in which the W-axis intersects with the U-axis relative to the rotating member 193b. The first adjustment member 195b has a convex curved surface inscribed on the concave curved surface of the base 195a. The first adjustment member 195b has the convex curved surface slidable along the concave curved surface and is retainably supported in an arbitrary position by the base 195a. That is, the first adjustment member 195b is rotatable around the W-axis and retainably supported in an arbitrary position (angle) by the base 195a.

The surface opposite to the surface supported by the base 195a in the first adjustment member 195b is formed in a concave curved surface as a circular arc in a plane perpendicular to the Y-axis direction. The axis passing through the center of the circular arc in parallel to the Y-axis is the above described V-axis. The concave curved surface is formed in a shape so that the V-axis may pass through a point at which the W-axis and the U-axis intersects. The point at which the U-axis, the W-axis, and the V-axis intersect is represented by an adjustment center point 500.

The second adjustment member 195c has a convex curved surface inscribed on the concave curved surface of the first adjustment member 195b. The second adjustment member 195c has the convex curved surface slidable along the concave curved surface and is retainably supported in an arbitrary position by the first adjustment member 195b. That is, the second adjustment member 195c is rotatable around the V-axis and retainably supported in an arbitrary position (angle) by the first adjustment member 195b.

As shown in FIGS. 6A and 6B, the retainer 171 includes a retainer base part 140, a center contact part 141, grippers 144, adjustment optical fibers 142, and curing optical fibers 143.

The retainer base part 140 is fixed to the second adjustment member 195c.

The center contact part 141 has an outer shape of a nearly rectangular parallel piped shape having a contact end surface 141a, has a hollow part 141b opening at one end of the rectangular parallel piped shape to the contact end surface 141a, and is stood on the retainer base part 140. Regarding the center contact part 141, in the example shown in FIG. 5, 6A, and 6B, the rectangular parallel piped shape protrudes from the end of the second adjustment member 195c in the X-axis direction and the contact end surface 141a at the end is a surface in parallel to the Y-axis direction and the Z-axis direction.

The grippers 144 have two sets of grippers 144a each having a grip base 145, a grip arm 146a, a grip projection 147a, a grip arm 146b, and a grip projection 147b. In the example shown in FIG. 5, 6A, and 6B, the grip bases 145 are fixed to the retainer base part 140, one at each side of the center contact part 141 stood on the retainer base part 140 in the Z-axis direction. The grip base 145 extends in the Y-axis direction.

The grip arm 146a and the grip arm 146b are slidable in the Y-axis direction and retainably supported in arbitrary positions by the grip base 145. The grip arm 146a and the grip arm 146b have nearly rectangular parallel piped shapes and extend nearly in parallel to the center contact part 141 in the Z-axis direction. On the ends of the grip arm 146a and the grip arm 146b at the opposite side to the side supported by the grip base 145, the grip projection 147a or the grip projection 147b is stood. The grip projection 147a and the grip projection 147b are projected on surfaces facing each other of the grip arm 146a and the grip arm 146b, and they move away from and closer to each other when the grip arm 146a and the grip arm 146b slide on the grip base 145 in the Y-axis direction. When the grip projection 147a or the grip projection 147b move closer to each other into contact with the both sides of the above described grip lugs 73, and thereby, the grippers 144 may grip the grip lugs 73.

The contact surfaces 72a of the modulation device unit 48 located in the positions in which the two sets of grippers 144a may respectively grip the grip lugs 73 can contact the contact end surface 141a of the center contact part 141. The wire grid 41 of the modulation device unit 48 has the opposite surface to the surface opposed to the light modulation device 42 and the polarizer 46 facing the opening of the hollow part 141b opening to the contact end surface 141a of the center contact part 141.

In the hollow part 141b of the center contact part 141, four of the adjustment optical fibers 142 are provided. The adjustment optical fibers 142 are connected to the above described adjustment light source unit and the lights output from the adjustment light source unit are output from the ends of the adjustment optical fibers 142. The respective adjustment optical fibers 142 are provided in the four corners of the hollow part 141b.

The ends of the adjustment optical fibers 142 respectively face the four corners of the wire grid 41 of the modulation device unit 48 in a state in which the two sets of grippers 144a respectively grip the grip lugs 73 and the contact surfaces 72a are in contact with the contact end surface 141a. The surface of the image display region 50a of the reflective liquid crystal panel 50 of the light modulation device 42 in the modulation device unit 48 in this state is in parallel to the X-axis direction and the Y-axis direction. The adjustment optical fibers 142 extend in the X-axis direction in the hollow part 141b, and output adjustment lights from their ends in the Y-axis direction. The adjustment lights output from the adjustment optical fibers 142 are respectively transmitted through the four corners of the wire grid 41, enters the four corners of the image display region 50a of the reflective liquid crystal panel 50, and are reflected and output. The adjustment lights output from the reflective liquid crystal panel 50 are reflected by the wire grid 41 and, via the cross dichroic prism 43, radiated on the transmissive screen 153 by the projection lens 3 to form an image.

The curing optical fibers 143 are provided in the Z-axis direction at both sides with the center contact part 141 in between. The curing optical fibers 143 are connected to the above described fixation light source unit and curing lights output from the fixation light source unit are output from the ends of the curing optical fibers 143. The curing lights output from the ends of the curing optical fibers 143 are radiated on the adhesive provided in the part of the projection optical unit 334 or the modulation device unit 48 held in the modulation device position adjuster 80 in which the engagement protrusions 79 and the engagement grooves 74 are loosely fitted. By curing the adhesive by the radiation of the curing lights, the engagement protrusions 79 are bonded and fixed to the engagement grooves 74. Thereby, the position of the modulation device unit 48 is fixed relative to the projection optical unit 334.

Next, the positional relationships of the reflective liquid crystal panel 50 of the modulation device unit 48 retained by the retainer 171 with the respective parts of the six-axis position adjustment unit 91 will be explained.

As described above, the modulated light output from the reflective liquid crystal panel 50 is reflected by the wire grid 41 and, via the cross dichroic prism 43, enters the projection lens 3. Accordingly, in the projection lens 3, the modulated light may be treated as light output from a virtual image of the reflective liquid crystal panel 50 by the wire grid 41. The virtual image of the reflective liquid crystal panel 50 by the wire grid 41 is represented by a reflection panel image 550. The point corresponding to the panel center 55 of the reflective liquid crystal panel 50 in the reflection panel image 550 is represented by a panel virtual image center 555.

The position of the modulation device unit 48 retained by the retainer 171 in the Y-axis direction relative to the six-axis position adjustment unit 91 is determined when the two sets of grippers 144a respectively grip the grip lugs 73. The position of the modulation device unit 48 in the X-axis direction relative to the six-axis position adjustment unit 91 is determined when the contact surfaces 72a of the modulation device unit 48 contact the contact end surface 141a of the center contact part 141. The position of the modulation device unit 48 in the Z-axis direction relative to the six-axis position adjustment unit 91 is determined when the grip projection 147a and the grip projection 147b contact a positioning member (not shown) formed on the attachment member 70.

The modulation device unit 48 is retained by the retainer 171 of the six-axis position adjustment unit 91 in a state in which the panel virtual image center 555 of the modulation device unit 48 is located at the adjustment center point 500 of the six-axis position adjustment unit 91 based on the design.

The retainer 171 corresponds to a unit retaining section. The position adjustment mechanism main body 190 corresponds to a position adjustment section. The adjustment center point 500 corresponds to an adjustment center. The panel virtual image center 555 corresponds to a center of the reflective light modulation device in the virtual image of the reflective light modulation device by the reflective polarizer.

### Modulation Device Position Adjustment Steps

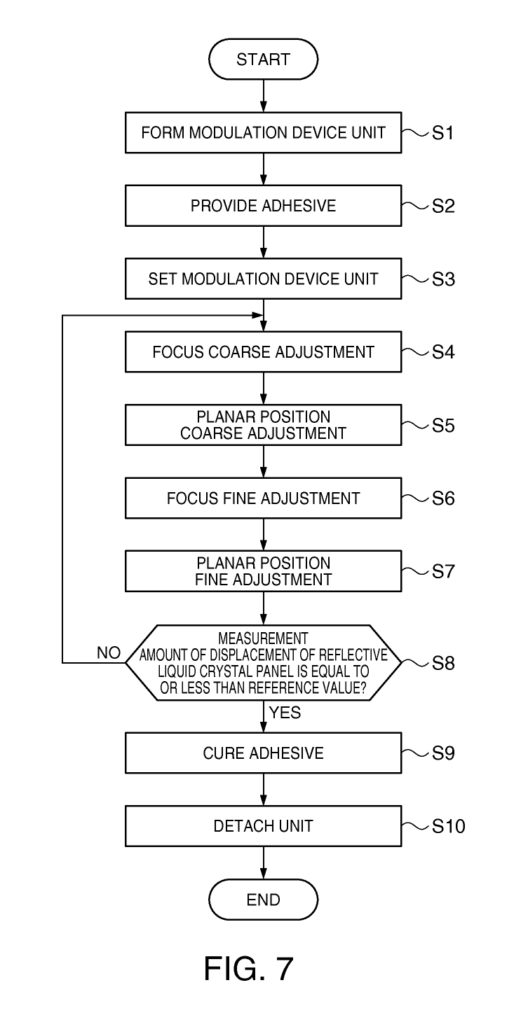

Next, steps of position-adjusting and fixing the modulation device unit 48 relative to the projection optical unit 334 using the modulation device position adjuster 80 will be explained with reference to FIG. 7. As described above, the steps of position-adjusting and fixing the modulation device unit 48 relative to the projection optical unit 334 are steps of position-adjusting and fixing the reflective liquid crystal panel 50 relative to the projection lens 3. FIG. 7 is a flowchart showing the steps of position-adjusting the reflective liquid crystal panel relative to the projection lens.

First, at step S1 in FIG. 7, the modulation device unit 48 is formed. As has been explained with reference to FIGS. 2A and 2B, the modulation device unit 48 is formed by fixing the wire grid 41, the light modulation device 42, and the polarizer 46 in the predetermined positions of the attachment member 70.

Then, at step S2 in FIG. 7, the adhesive is provided in the engagement grooves 74. For the adhesive, in the embodiment, a UV curing adhesive is used. It is preferable that the adhesive has high viscosity for suppressing outflow before curing. Alternatively, a temporary curing step of curing only the surface of the adhesive provided in the engagement grooves 74 may be performed.

Then, at step S3, the modulation device unit 48 is set in the modulation device position adjuster 80. In advance, the projection optical unit 334 is fixed to the clamp jig 93 of the modulation device position adjuster 80. Then, the attachment member 70 is attached to the adjustment member 76 in the state in which the engagement protrusions 79 of the adjustment member 76 are loosely fitted in the engagement grooves 74. That is, the modulation device unit 48 is attached to the projection optical unit 334 so that the position may be adjustable. In the state in which the engagement protrusions 79 are loosely fitted in the engagement grooves 74, the attachment member 70 of the modulation device unit 48 is retained by the retainer 171 of the six-axis position adjustment unit 91 of the modulation device position adjuster 80, and thereby, the modulation device unit 48 is set in the modulation device position adjuster 80.

As has been explained with reference to FIGS. 5, 6A, and 6B, the modulation device unit 48 is retained by the retainer 171 of the six-axis position adjustment unit 91 in the state in which the panel virtual image center 555 of the modulation device unit 48 is located at the adjustment center point 500 of the six-axis position adjustment unit 91 based on the design.

Then, at step S4 in FIG. 7, focus coarse adjustment of the reflective liquid crystal panel 50 is performed. The step of focus adjustment is a step of adjusting the position of the reflective liquid crystal panel 50 in the optical axis direction of the projection lens 3 with respect to the focal position of the projection lens 3. The step of focus coarse adjustment is respectively performed for the light modulation device 42R, the light modulation device 42G, and the light modulation device 42B.

As described above, in the projection lens 3, the modulated light output from the reflective liquid crystal panel 50 of the modulation device unit 48 may be treated as light output from the reflection panel image 550 as the virtual image of the reflective liquid crystal panel 50 by the wire grid 41. The focus adjustment of the reflective liquid crystal panel 50 is performed by correcting the tilt of the reflection panel image 550 relative to the optical axis of the projection lens 3 and the displacement in the optical axis direction of the projection lens 3 from the design-based position.

In the reflection panel image 550 in the modulation device unit 48 retained by the retainer 171, the planar direction of the image display region 50a is perpendicular to the U-axis and the panel virtual image center 555 is located at the adjustment center point 500 based on the design.

First, whether or not the reflective liquid crystal panel 50 (reflection panel image 550) is in an appropriate position in the optical axis direction of the projection lens 3 is determined, and an amount of shift to be located in the appropriate position is obtained. Specifically, image information is acquired by imaging the four corners of the projection image formed on the transmissive screen 153 using the four CCD cameras 155. Whether or not the images of the four corners are focused or not is determined by analyzing the image information. In the modulation device position adjuster 80, the positions of the projection lens 3 of the projection optical unit 334 held by the clamp jig 93 and the transmissive screen 153 are appropriately adjusted. The defocus of the image on the transmissive screen 153 is caused because the position of the reflective liquid crystal panel 50 (reflection panel image 550) relative to the projection lens 3 is displaced from the appropriate position.

From the image information by the CCD cameras 155, whether or not the positions in the optical axis direction of the projection lens 3 of the parts to which the lights of the parts imaged by the CCD cameras 155 in the reflective liquid crystal panel 50 (reflection panel image 550) are output are appropriate is determined. Further, an amount of correction shift in the optical axis direction of the projection lens 3 for positioning in the appropriate position is obtained. By comparison among the image information by the four CCD cameras 155, whether or not the positions in the optical axis direction of the projection lens 3 of the respective four corners of the reflective liquid crystal panel 50 (reflection panel image 550) are appropriate, that is, whether or not the reflective liquid crystal panel 50 (reflection panel image 550) is tilted relative to the surface orthogonal to the optical axis direction of the projection lens 3 is determined. Further, an amount of tilt correction for correcting the tilt is obtained.

Then, correction is performed based on the obtained amount of correction shift and amount of tilt correction.

As described above, in the six-axis position adjustment unit 91, the base 191a of the planar position adjustment part 191 moves in the U-axis direction (in the X-axis direction for adjustment of the light modulation device 42G and in the Y-axis direction for adjustment of the light modulation device 42R or 42B) with respect to the pedestal 95. By the movement, the modulation device unit 48 retained by the retainer 171 is moved in the U-axis direction by the obtained amount of correction shift, and the position in the optical axis direction of the projection lens 3 is corrected.

As described above, in the six-axis position adjustment unit 91, the plane tilt adjustment part 195 has the function of performing adjustment of the tilt of the modulation device unit 48 (reflective liquid crystal panel 50) relative to the plane in parallel to the luminous flux incident-side end surface 44 of the cross dichroic prism 43. The planar direction of the luminous flux incident-side end surface 44 is perpendicular to the optical axis direction of the projection lens 3 based on the design, and the plane tilt adjustment part 195 may adjust the tilt of the reflective liquid crystal panel 50 (reflection panel image 550) relative to the plane orthogonal to the optical axis direction of the projection lens 3. By the plane tilt adjustment part 195, the modulation device unit 48 retained by the retainer 171 is rotated around the W-axis and the V-axis, and the tilt relative to the plane orthogonal to the optical axis direction of the projection lens 3 is changed. By rotating the angle corresponding to the obtained amount of tilt correction, the tilt of the reflective liquid crystal panel 50 (reflection panel image 550) relative to the plane orthogonal to the optical axis direction of the projection lens 3 is adjusted.

Then, at step S5 in FIG. 7, coarse adjustment of the planar position of the reflective liquid crystal panel 50 is performed. The step of adjusting the planar position is a step of adjusting the position and the tilt of the reflective liquid crystal panel 50 in the planar direction in parallel to the surface of the image display region 50a. The step of adjusting the planar position is respectively performed for the light modulation device 42R, the light modulation device 42G, and the light modulation device 42B.

The adjustment of the planar position of the reflective liquid crystal panel 50 is performed by correcting errors of the tilt and the position of the reflection panel image 550 in the planar direction orthogonal to the optical axis direction of the projection lens 3 from the design-based tilt and position.

First, whether or not the reflective liquid crystal panel 50 (reflection panel image 550) is in an appropriate position and at an appropriate tilt in the planar direction orthogonal to the optical axis direction of the projection lens 3 is determined, and an amount of shift and an amount of rotation to be located in the appropriate position at the appropriate tilt are obtained. Specifically, position information of images of pixels on ends of the four corners of the image display region in the reflection panel image 550 is acquired by imaging the four corners of the projection image formed on the transmissive screen 153 using the four CCD cameras 155. From the position information of the images of the four pixels, errors of the position and the tilt of the image display region from the design-based position and tilt are obtained. Further, the amount of correction shift and the amount of correction rotation for correction of the errors are obtained. The design-based position of the image display region is a position in which the center of the image display region having the nearly rectangular shape is on the U-axis and the respective sides of the nearly rectangular shape are in parallel to the V-axis direction or the W-axis direction.

Then, correction is performed based on the obtained amount of correction shift and amount of correction rotation.

As described above, in the six-axis position adjustment unit 91 that performs position adjustment of the light modulation device 42G, the Y-axis shift member 191b of the planar position adjustment part 191 is slidable in the Y-axis direction and retainably supported in an arbitrary position by the base 191a. The Z-axis shift member 191c is slidable in the Z-axis direction and retainably supported in an arbitrary position by the Y-axis shift member 191b. The Y-axis direction is the V-axis direction shown in FIGS. 6A and 6B and the Z-axis direction is the W-axis direction shown in FIGS. 6A and 6B.

By the planar position adjustment part 191, the modulation device unit 48 retained by the retainer 171 may be moved by the obtained amount of correction shift in the planar direction in parallel to the V-axis direction and the W-axis direction, and thereby, the position of the reflective liquid crystal panel 50 (reflection panel image 550) in the planar direction is adjusted.

As described above, in the six-axis position adjustment unit 91, the in-plane rotational position adjustment part 193 includes the base 193a and the rotating member 193b. The in-plane rotational position adjustment part 193 has a function of performing adjustment of the rotational position around the U-axis. The planar direction of the image display region of the reflection panel image 550 in the modulation device unit 48 retained by the retainer 171 is perpendicular to the U-axis direction and perpendicular to the optical axis direction of the projection lens 3 based on the design.

By the in-plane rotational position adjustment part 193, the modulation device unit 48 retained by the retainer 171 is rotated by the obtained amount of correction rotation around the U-axis, and thereby, the tilt of the reflective liquid crystal panel 50 (reflection panel image 550) in the planar direction is adjusted.

Then, at step S6, focus fine adjustment of the reflective liquid crystal panel 50 is performed. At the step of focus fine adjustment, the adjustment of the position of the reflective liquid crystal panel 50 in the optical axis direction of the projection lens 3 relative to the focal position of the projection lens 3 that may have been displaced by the planar position coarse adjustment after focus coarse adjustment is performed again. The step of focus fine adjustment is performed in the same manner as that of the step of focus coarse adjustment.

Then, at step S7, fine adjustment of the planar position of the reflective liquid crystal panel 50 is performed. At the fine adjustment step of the planar position, the planar positions of the reflective liquid crystal panel 50 of the light modulation device 42R, the light modulation device 42G, and the light modulation device 42B that have respectively been position-adjusted at the coarse adjustment step of the planar position may be the same. For example, first, the adjustment of the planar position of the reflective liquid crystal panel 50 of the light modulation device 42G is performed. Then, the positions of the pixels of the reflective liquid crystal panels 50 of the light modulation device 42R and the light modulation device 42B are adjusted to be the same as the positions of the pixels of the reflective liquid crystal panel 50 of the light modulation device 42G, for which the adjustment of the planar position has been performed first. The fine adjustment steps of the respective planar positions of the light modulation device 42R, the light modulation device 42G, and the light modulation device 42B are performed in the same manner as that of the coarse adjustment steps of the planar positions.

Then, at step S8, the position of the reflective liquid crystal panel 50 relative to the projection lens 3 is measured, and whether or not the amount of displacement satisfies a reference value is determined.

If the amount of displacement does not satisfy the reference value (NO at step S8), the process returns to step S4, and steps S4 to S8 are performed again and the position adjustment of the reflective liquid crystal panel 50 is performed again.

If the amount of displacement satisfies the reference value (YES at step S8), the process moves to step S9.

At step S9, the adhesive is cured. By outputting the curing lights from the curing optical fibers 143, the adhesive provided in the engagement grooves 74 is cured. Thereby, the engagement protrusions 79 and the engagement grooves 74 that have been loosely fitted to be movable relative to each other are fixed and the position of the reflective liquid crystal panel 50 relative to the projection lens 3 is fixed.

Then, at step S10, the unit in which the projection optical unit 334 and the three modulation device units 48 are integrated is detached from the modulation device position adjuster 80.

By performing step S10 and position-adjusting and fixing the modulation device unit 48 relative to the projection optical unit 334, the step of position-adjusting and fixing the reflective liquid crystal panel 50 relative to the projection lens 3 is ended.

As below, advantages of the embodiment will be described. According to the embodiment, the following advantages are obtained.

(1) The modulation device unit 48 includes the attachment member 70 and the reflective liquid crystal panel 50 and the wire grid 41 are fixed to the attachment member 70. Thereby, only by fixing the reflective liquid crystal panel 50 and the wire grid 41 to predetermined positions of the attachment member 70, the reflective liquid crystal panel 50 and the wire grid 41 may be provided in an appropriate positional relationship with each other.

(2) The adjustment member 76 has the engagement protrusions 79 and the attachment member 70 has the engagement grooves 74. The adjustment member 76 is fixed to the projection optical unit 334 containing the projection lens 3, and the reflective liquid crystal panel 50 and the wire grid 41 are fixed to the attachment member 70. The attachment member 70 is attached to the adjustment member 76 by loosely fitting the engagement protrusions 79 in the engagement grooves 74. Thereby, the reflective liquid crystal panel 50 may be moved relative to the projection lens 3 by the gaps between the loose fitted engagement protrusions 79 and engagement grooves 74.

(3) The in-plane rotational position adjustment part 193 includes the base 193a and the rotating member 193b. The rotating member 193b is rotatable around the center axis passing through the adjustment center point 500 (U-axis) and retainably supported in an arbitrary position by the base 193a. The modulation device unit 48 is retained by the retainer 171 supported by the rotating member 193b via the plane tilt adjustment part 195 in the state in which the panel virtual image center 555 is located at the adjustment center point 500 of the six-axis position adjustment unit 91. Thereby, the modulation device unit 48 is rotated around the U-axis around the panel virtual image center 555, and the tilt around the U-axis may be adjusted.

(4) The plane tilt adjustment part 195 includes the base 195a and the first adjustment member 195b. The first adjustment member 195b is rotatable around the center axis passing through the adjustment center point 500 (W-axis) and retainably supported in an arbitrary position by the base 195a. The modulation device unit 48 is retained by the retainer 171 supported by the first adjustment member 195b via the second adjustment member 195c in the state in which the panel virtual image center 555 is located at the adjustment center point 500 of the six-axis position adjustment unit 91. Thereby, the modulation device unit 48 is rotated around the W-axis around the panel virtual image center 555, and the tilt around the W-axis may be adjusted.

(5) The plane tilt adjustment part 195 includes the base 195a, the first adjustment member 195b, and the second adjustment member 195c. The second adjustment member 195c is rotatable around the passing through the adjustment center point 500 (V-axis) and retainably supported in an arbitrary position by the first adjustment member 195b. The first adjustment member 195b is supported by the base 195a. The modulation device unit 48 is retained by the retainer 171 supported by the second adjustment member 195c in the state in which the panel virtual image center 555 is located at the adjustment center point 500 of the six-axis position adjustment unit 91. Thereby, the modulation device unit 48 is rotated around the V-axis around the panel virtual image center 555, and the tilt around the V-axis may be adjusted.

The embodiment of the invention has been explained as above, and various changes may be made to the embodiment without departing from the scope of the invention. As modified examples, the following examples are conceivable, for example.

### Modified Example 1

In the embodiment, the fixation of the engagement protrusions 79 and the engagement grooves 74 has been performed by curing the light curing adhesive provided in the engagement grooves 74, however, the adhesive is not limited to the light curing adhesive. The adhesive may be a thermosetting adhesive. The fixing method is not limited to the fixation using the adhesive. The fixing method may be a fixing method by curing a fixing material melted at a high temperature using solder, a thermoplastic resin, or the like.

### Modified Example 2

In the embodiment, the positions of the engagement grooves 74 have not particularly been designated, however, they may be provided in positions in which the W-axis penetrates the engagement grooves 74. By providing the engagement grooves 74 in the position that the W-axis penetrates, the amounts of shift of the engagement grooves 74 in the direction crossing the W-axis at the adjustment of the rotational position around the W-axis may be reduced. By reducing the amounts of shift of the engagement grooves 74, the gaps between the engagement protrusions 79 and the engagement grooves 74 in the state in which the engagement protrusions 79 and the engagement grooves 74 are loosely fitted may be reduced.

### Modified Example 3

In the embodiment, the projector 1 is the projector using the three reflective liquid crystal panels 50, however, the number of reflective light modulation devices that the projection apparatus has is not limited to three. For example, the invention may be applied to a projection apparatus using one, two, four, or more reflective light modulation devices. In this case, the projection apparatus includes the reflective polarizers, the adjustment support sections, etc. in the same number as that of the reflective light modulation devices.

### Modified Example 4

In the embodiment, the projector 1 is the front-projection-type projector that projects a projection image from the side of observation, however, the projector is not limited to the front-projection-type projector. The projector may be a rear-projection-type projector that projects a projection image from the opposite side to the side of observation.

The entire disclosure of Japanese Patent Application No. 2010-155491, filed Jul. 8, 2010 is expressly incorporated by reference herein.

What is claimed is:

1. A manufacturing method of a projection apparatus including a reflective light modulation device that optically modulates incident light and outputs a modulated light formed by the modulation of the incident light and a reflective polarizer that transmits the incident light output from a light source and reflects the modulated light toward a projection optical device, the method comprising:
a unit formation step of forming a modulation device unit having the reflective light modulation device and the reflective polarizer, the reflective light modulation device and the reflective polarizer fixed to predetermined relative positions; and
a position adjustment step of adjusting a position of the reflective light modulation device relative to the projection optical device by shifting a position of the modulation device unit with respect to the projection optical device.

2. The manufacturing method of the projection apparatus according to claim 1, wherein, at the position adjustment step, six-axis adjustment is performed, and position adjustment in rotation directions around axes adjusts the position in rotation directions around the respective axes of the three axes crossing one another at a center of the reflective light modulation device in a virtual image of the reflective light modulation device by the reflective polarizer.

3. Manufacturing equipment of a projection apparatus including a reflective light modulation device that optically modulates incident light and outputs a modulated light formed by the modulation of the incident light and a reflective polarizer that transmits the incident light output from a light source and reflects the modulated light toward a projection optical device, the equipment comprising:
a unit retaining section of retaining a modulation device unit in which the reflective light modulation device and the reflective polarizer are fixed in a predetermined positional relationship; and
a position adjustment section of adjusting a position of the reflective light modulation device relative to the projection optical device by shifting a position of the modulation device unit retained by the unit retaining section with respect to the projection optical device.

4. The manufacturing equipment of the projection apparatus according to claim 3, wherein the position adjustment section performs six-axis adjustment, and three rotational axes at adjustment of rotation directions around axes cross one another at an adjustment center, and
the unit retaining section retains the modulation device unit by positioning a center of the reflective light modulation device in a virtual image of the reflective light modulation device by the reflective polarizer at the adjustment center.

5. A projection apparatus comprising:
a reflective light modulation device that optically modulates incident light and outputs a modulated light formed by the modulation of the incident light;
a reflective polarizer that transmits the incident light output from a light source and reflects the modulated light toward a projection optical device;
a modulation device frame to which the reflective light modulation device and the reflective polarizer are fixed and in which a positional relationship between the reflective light modulation device and the reflective polarizer is maintained in a predetermined positional relationship by the fixation; and
an adjustment support section that may position-adjusts the modulation device frame relative to the projection optical device and fixably supports the positions of the reflective light modulation device and the reflective polarizer fixed to the modulation device frame relative to the projection optical device by a fixing section.

6. The projection apparatus according to claim 5, wherein the adjustment support section rotatably supports the modulation device frame around three axes orthogonal to one another at a center of the reflective light modulation device in a virtual image of the reflective light modulation device by the reflective polarizer in a state in which the section is not fixed by the fixing section.

7. The projection apparatus according to claim 6, wherein the adjustment support section is provided in a position in which one axis of the three axes crossing one another through the center of the reflective light modulation device in the virtual image of the reflective light modulation device by the reflective polarizer penetrate the adjustment support section.
